(19) United States
(12) Patent Application Publication
(10) Pub. No.: US 2022/0021496 A1
(43) Pub. Date: Jan. 20, 2022

(54) CSI-RS Resource Reuse

(71) Applicant: TELEFONAKTIEBOLAGET LM ERICSSON (PUBL), Stockholm (SE)

(72) Inventors: Akram BIN SEDIQ, Kanata (CA); Magnus HURD, STOCKHOLM (SE)

(21) Appl. No.: 17/295,615

(22) PCT Filed: Dec. 21, 2018
(86) PCT No.: PCT/IB2018/060539

§ 371 Date: May 20, 2021

(51) Int. Cl. H04L 5/00; H04L 1/00; H04B 7/06

(52) U.S. Cl. CPC H04L 5/0048; H04B 7/0626; H04L 1/0013

(57) ABSTRACT

Embodiments of a method in a wireless access node are disclosed. A method in an access node of a wireless network, the method comprises: transmitting a first Non-Zero Power (NZP) Channel State Information Reference Signal (CSI-RS) in a first set of resource elements of a subframe, the first NZP CSI-RS having a respective first number of ports; transmitting at least one second NZP CSI-RS in a second set of resource elements of the subframe, the second set of resource elements being a subset of the first set of resource elements, each second NZP CSI-RS having a respective second number of ports that is less than the first number of ports; and configuring at least one user equipment (UE) to perform rate matching using one or more Zero Power (ZP) CSI-RSs in a third set of resource elements of the subframe, the third set of resource elements overlapping the first set of resource elements and not overlapping the second set of resource elements.

### TECHNICAL FIELD

The present disclosure relates to access network management, and in particular to configuring wireless devices operating in a radio access network.

### BACKGROUND

FIG. 1A illustrates a conventional wireless network environment 100 in which a radio access node 102 is configured to transmit and received radio signals to and from wireless devices 104a-104c within a cell 106 hosted by the access node 102.

Using a massive antenna grid 108 encompassing many discrete antenna elements 110 as is shown in FIG. 1B provides opportunities to steer a transmission from a base station to a device. However, in order to realize these opportunities the base station needs reliable channel state information (CSI) regarding the state of a given User Equipment (UE) in order to select appropriate beamforming weights for each antenna element. Moreover, the base station needs to select parameters such as modulation and code rate for an intended transmission to a device.

CSI measurement in New Radio (NR) is facilitated through the transmission of one or more CSI reference signal (CSI-RS) resources. A CSI-RS resource comprises one or more downlink time-frequency resource elements (REs) with Radio Resource Control (RRC)-configurable attributes, to be used by the UE to perform measurements. According to 3GPP TS 38.211 V15.1.0 (2018-03) and 3GPP TS 38.214 V15.1.0 (2018-03), three types of CSI-RS resources are defined:
Non-Zero-Power CSI-RS (NZP-CSI-RS): These resources are transmitted by gNB carrying predetermined reference signals that can be used by the UE to estimate the channel. NZP CSI-RS can also be used for interference measurement, typically, intra-cell interference, such as interference due to co-scheduled MU-MIMO UEs.
Zero-Power CSI-RS (ZP-CSI-RS): These resources are used for rate matching. For example, 3GPP TS 38.211 V15.1.0 (2018-03) defines that the UE shall assume that the REs occupied by ZP-CSI-RS are not used for Physical Downlink Shared Channel (PDSCH) transmission.
CSI-Interference Measurement (CSI-IM): These resources are used for interference measurement, typically, inter-cell interference.

To illustrate the use of the above three types of resource, we consider the case of obtaining channel-quality-indicator (CQI). For the UE to estimate CQI, it needs to estimate the channel strength as well as the interference plus noise. One way to facilitate such estimations is by configuring the UE with the following:
NZP CSI-RS to estimate the channel
CSI-IM to estimate the interference, where gNB does not transmit any signal in these CSI-IM resources so the UE can measure inter-cell interference plus noise in these resources
One or more ZP-CSI-RS resource for the same REs that constitute CSI-IM, in order to inform the UE that no PDSCH transmission is occurring in these REs.

Selecting beamforming weights (precoding) is typically done in one of two different ways: (a) precoding based on the device measuring on one or more CSI-RS resources, which is referred to as codebook-based precoding hereafter; (b) precoding based on measuring any uplink transmissions from the device, which is referred to as reciprocity-based precoding hereafter.

In codebook-based precoding, the CSI-RS resources used makes it possible to present to the UE the complicated AAS grid as ports. The ports have a relation to the Antenna elements but does not need to be one-to-one mapped to the antenna elements. Basically, each CSI-RS port transmits a pilot signal on a dedicated set of resource elements; these resource elements may be shared between several ports by means of code division multiplexing (CDM). The UE would measure on all CSI-RS ports to select a precoder (represented by an index PMI) predefined in a codebook. More ports enables more spectral efficient selections of PMI by the UE at the cost of some overhead since an increased amount of resource elements (REs) will be required for CSI-RS resources which in turn reduce the available REs for PDSCH. In NR release 15, the maximum number of CSI-RS ports is 32. However, it is expected that not all UEs will be capable of measuring CSI-RS resources based on this maximum number of ports. In fact, it is expected that different UEs will have different capabilities specifying different maximum number of ports that they can measure. The UE is also expected to indicate the CQI representing the SINR; the estimated CQI can be based on measuring the CSI-RS resource as is used to estimate PMI.

In reciprocity-based precoding, the downlink and uplink channel are reciprocal to each other. Thus, the downlink channel can be estimated by measuring any uplink transmission, without the need for any explicit feedback from the UE. However, the base-station needs also to estimate the interference-plus-noise measured by the UE in the downlink, which is not typically reciprocal in the downlink and uplink. Hence, CSI-RS resources are still needed and explicit CQI feedback from the UE is required so the base-station can estimate the interference-plus-noise. Nevertheless, estimating interference-plus-noise typically requires fewer CSI-RS ports.

In NR the UEs are configured with CSI-RS resources on an individual basis, by means of RRC configuration messages from the gNB. These resources can be shared, in that the same resource may be assigned to more than one UE, and each involved UE measures on the same set of resource elements. However, different UEs may need to measure and report CSI based on different numbers of ports, depending on their capabilities and/or whether the gNB is using codebook based precoding or reciprocity-based precoding.

If one wants to allow different UEs to measure CSI based on different numbers of ports, then corresponding different numbers of CSI-RS resources need to be defined and configured. Defining multiple CSI-RS resources independently from each other introduces increased overhead due to the inherently increased number of resource elements needed to transmit the different CSI-RSs.

Techniques enabling different UEs to measure CSI based on different numbers of ports, with minimum overhead, are highly desirable.

### SUMMARY

An object of the present invention is to provide techniques that overcome at least some of the above-noted limitations of the prior art.

Accordingly, an aspect of the present invention provides a method in an access node of a wireless communications network. The method comprises: transmitting a first Non-Zero Power (NZP) Channel State Information Reference Signal (CSI-RS) in a first set of resource elements of a subframe, the first NZP CSI-RS having a respective first number of ports; transmitting at least one second NZP CSI-RS in a second set of resource elements of the subframe, the second set of resource elements being a subset of the first set of resource elements, each second NZP CSI-RS having a respective second number of ports that is less than the first number of ports; and configuring at least one user equipment (UE) to perform rate matching using one or more Zero Power (ZP) CSI-RSs in a third set of resource elements of the subframe, the third set of resource elements overlapping the first set of resource elements and not overlapping the second set of resource elements.

Embodiments of a base station, communication system, and a method in a communication system are also disclosed.

### BRIEF DESCRIPTION OF THE DRAWINGS

The accompanying drawing figures incorporated in and forming a part of this specification illustrate several aspects of the disclosure, and together with the description serve to explain principles of the disclosure.

FIGS. 1A and 1B schematically illustrate elements of a wireless network known in the art and usable in embodiments of the present invention;

FIGS. 2A and 2B schematically illustrate CSI-RS resource configurations known in the art;

FIGS. 3A and 3B schematically illustrate CSI-RS resource configurations in accordance with representative embodiments of the present invention;

FIG. 4 is a table showing configuration combinations usable in representative embodiments of the present invention;

FIG. 5 is a schematic block diagram of a radio access node according to some embodiments of the present disclosure;

FIG. 6 is a schematic block diagram that illustrates a virtualized embodiment of the radio access node of FIG. 5 according to some embodiments of the present disclosure;

FIG. 7 is a schematic block diagram of the radio access node of FIG. 5 according to some other embodiments of the present disclosure;

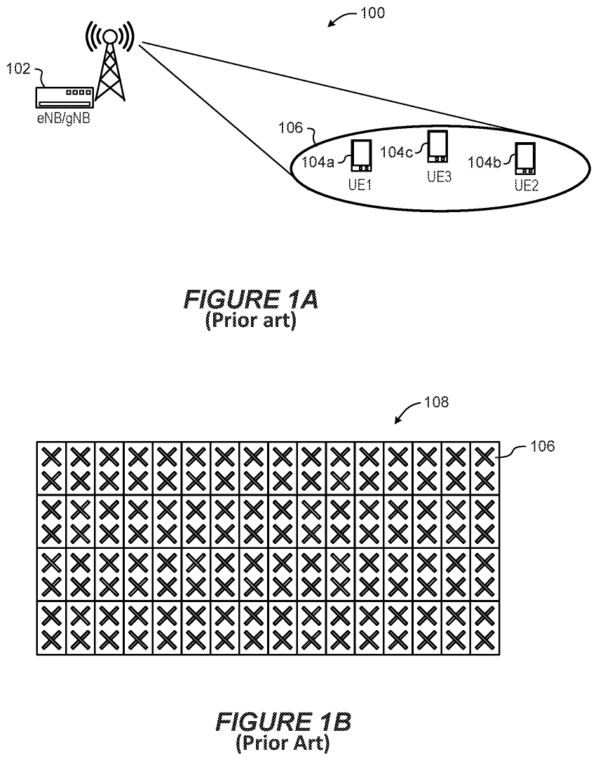

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

At least some of the following abbreviations and terms may be used in this disclosure.
2D Two Dimensional
3GPP Third Generation Partnership Project
5G Fifth Generation
AAS Antenna Array System
AoA Angle of Arrival
AoD Angle of Departure
ASIC Application Specific Integrated Circuit
BF Beamforming
BLER Block Error Rate
BW Beamwidth
CPU Central Processing Unit
CSI Channel State Information
dB Decibel
DCI Downlink Control Information
DFT Discrete Fourier Transform
DSP Digital Signal Processor
eNB Enhanced or Evolved Node B
FIR Finite Impulse Response
FPGA Field Programmable Gate Array
gNB New Radio Base Station
ICC Information Carrying Capacity
IIR Infinite Impulse Response
LTE Long Term Evolution
MIMO Multiple Input Multiple Output
MME Mobility Management Entity
MMSE Minimum Mean Square Error
MTC Machine Type Communication
NR New Radio
OTT Over-the-Top
PBCH Physical Broadcast Channel
PDCCH Physical Downlink Control Channel
PDSCH Physical Downlink Shared Channel
P-GW Packet Data Network Gateway
RAM Random Access Memory
ROM Read Only Memory
RRC Radio Resource Control
RRH Remote Radio Head
SCEF Service Capability Exposure Function
SINR Signal to Interference plus Noise Ratio
TBS Transmission Block Size
UE User Equipment
ULA Uniform Linear Array
URA Uniform Rectangular Array

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GVV), a Service Capability Exposure Function (SCEF), or the like.

Wireless Device: As used herein, a “wireless device” is any type of device that has access to (i.e., is served by) a cellular communications network by wirelessly transmitting (and/or receiving) signals to (and/or from) a radio access node. Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Cell: As used herein, a “cell” is a combination of radio resources (such as, for example, antenna port allocation, time and frequency) that a wireless device may use to exchange radio signals with a radio access node, which may be referred to as a host node or a serving node of the cell. However, it is important to note that beams may be used instead of cells, particularly with respect to 5G NR. As such, it should be appreciated that the techniques described herein are equally applicable to both cells and beams.

Note that references in this disclosure to various standards (such as 3GPP TS 38.211 V15.1.0 (2018-03) and 3GPP TS 38.214 V15.1.0 (2018-03), for example) should be understood to also refer to any applicable successors of such standards.

Note that the description herein focuses on a 3GPP cellular communications system and, as such, 3GPP terminology or terminology similar to 3GPP terminology is oftentimes used. However, the concepts disclosed herein are not limited to a 3GPP system.

Systems and methods are disclosed herein that allows the reuse of an m-port CSI-RS resource to support one or more n-port CSI-RS resources, where m>n. In general terms, a subset of the resource elements assigned to an m-port CSI-RS resource may also be assigned to one or more n-port CSI-RS resources. Depending on a given UE's configuration, which is done by the base-station, the UE will be measuring channel state using the resource elements according to either the m-port CSI-RS or an n-port CSI-RS.

For ease of description, it is useful to consider example embodiments in which there is a single m-port CSI-RS and a single n-port CSI-RS. However, it will be appreciated that other embodiments may be configured with more than one n-port CSI-RS. Preferably, m≥Σᵢnᵢ, where i is an index of each n-port CSI-RS.

The following description starts with an example embodiment where m=32 ports and n=2 ports, and then continues with some variants of this example. The m=32-port CSI-RS may be configured according to row 16 in table 7.4.1.5.3-1 of 3GPP TS 38.211 V15.1.0 (2018-03), and so may be referred to as a row 16, 32-port CSI-RS). Similarly, the n=2-port CSI-RS may be configured according to row 3 in table 7.4.1.5.3-1 of 3GPP TS 38.211 V15.1.0 (2018-03), and so may be referred to as a row 3, 2-port CSI-RS. In both cases, FD-CDM2 may be used. Details of table 7.4.1.5.3-1 are explained in 3GPP TS 38.211 V15.1.0 (2018-03), and so will not be described herein.

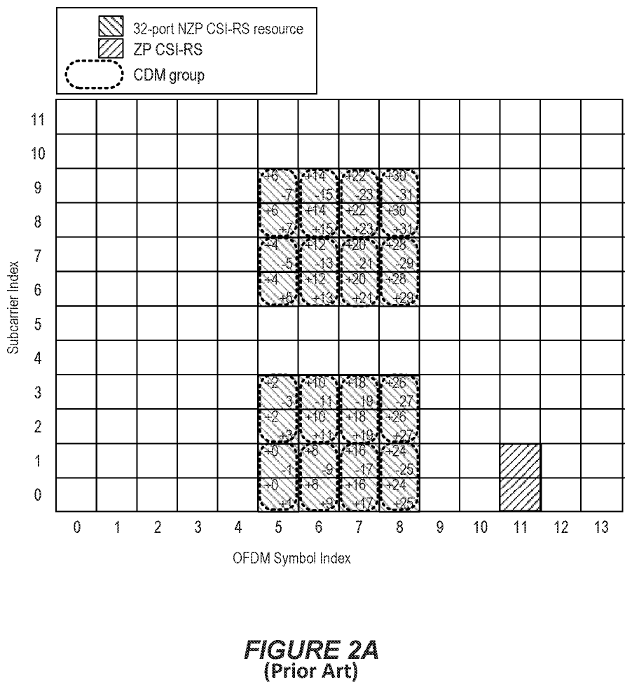

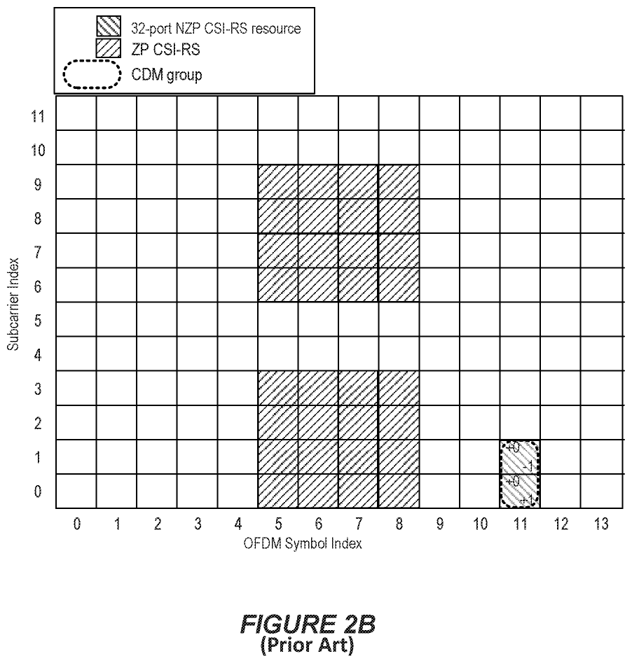

FIGS. 2A and 2B illustrate a conventional transmission subframe comprising 14 OFDM symbols on each one of 12 subcarriers. In this subframe, each subcarrier/OFDM symbol combination represents a single resource element (RE). Prior-art configurations of CSI-RS resources fora row 16, 32-port CSI-RS and a row 3, 2-port CSI-RS are shown in FIG. 2A and FIG. 2B, respectively. In both of these figures REs allocated to NZP CSI-RS and ZP CSI-RS are shown with respective different shading. For REs allocated to NZP CSI-RS, representative port numbers are also shown in each RE. For simplicity, the illustrated port numbering in FIGS. 2A and 2B start from 0, rather than 3000 as defined in 3GPP TS 38.211 V15.1.0 (2018-03). That is, the actual port number as set out in the standard can be obtained by adding 3000 to the port numbers shown in these figures. In addition, the illustrated port numbers are prefixed by “+” or “−” to indicate sign applied by the CDM pattern on the transmitted complex symbol for each port in each RE.

Consider a scenario in which one UE (for example, UE1) is configured to do CSI feedback based on a 32-port NZP CSI-RS, and a second UE (for example, UE2) is configured to do CSI feedback based on a 2-port NZP CSI-RS. In this scenario, UE1 configured to do CSI feedback based on the 32-port NZP CSI-RS resource shown in FIG. 2A, but also needs a ZP CSI-RS resource allocation corresponding to the 2-port NZP CSI-RS resource allocation for UE2. Inversely, UE2 is configured to do CSI feedback based on the 2-port NZP CSI-RS resource as in FIG. 2B but also needs a ZP CSI-RS resource allocation corresponding to the 32-port NZP CSI-RS resource allocation of UE1.

The configurations in FIGS. 2A and 2B are inefficient because each NZP CSI-RS resource must be allocated to a respective different set of REs within the subframe.

In accordance with embodiments of the present invention, one or more n-port NZP CSI-RS resources may be allocated to a common set of REs with a single m-port NZP CSI-RS resource), where n<m. More particularly, embodiments of the present invention provide methods and systems in which:
a first Non-Zero Power (NZP) Channel State Information Reference Signal (CSI-RS) is transmitted in a first set of resource elements of a subframe, the first NZP CSI-RS having a respective first number of ports;
at least one second NZP CSI-RS is transmitted in a second set of resource elements of the subframe, the second set of resource elements being a subset of the first set of resource elements, each second NZP CSI-RS having a respective second number of ports that is less than the first number of ports; and
at least one user equipment (UE) is configured to perform rate matching using one or more Zero Power (ZP) CSI-RSs in a third set of resource elements of the subframe, the third set of resource elements overlapping the first set of resource elements and not overlapping the second set of resource elements.

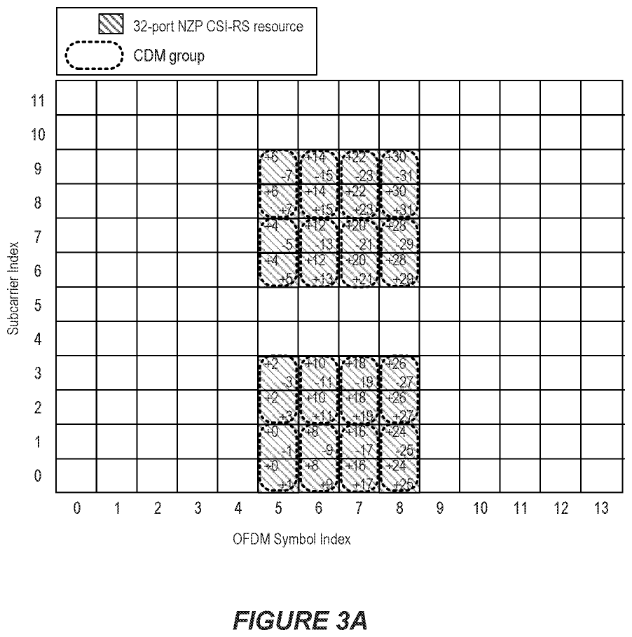

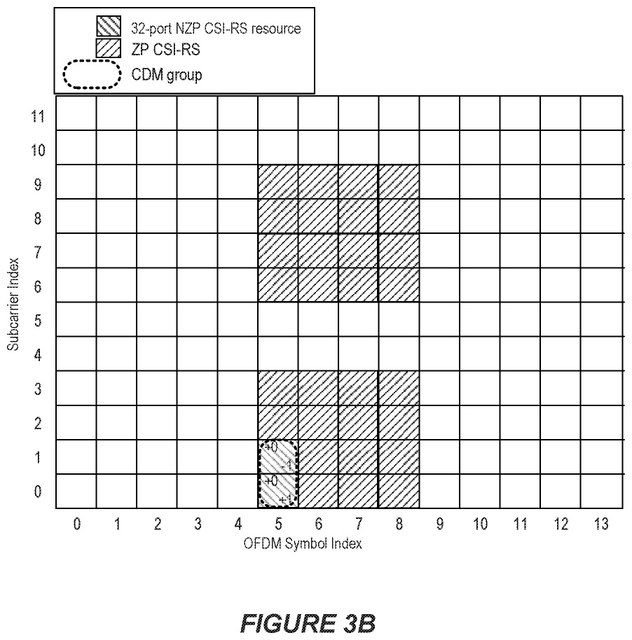

An example of this configuration is illustrated in FIGS. 3A and 3B.

As can be seen from FIGS. 3A and 3B, the 2-port CSI-RS resource is allocated to two REs that are also allocated to the larger 32-port CSI-RS resource. A particular UE configured to provide CSI feedback based on the m=32-port CSI-RS resource does not need a ZP CSI-RS resource in this case. On the other hand, a particular UE configured to provide CSI feedback based on the n=2-port CSI-RS resource still need one or more ZP CSI-RS resources to perform rate matching on PDSCH. The ZP CSI-RS resource(s) needed cover at least the (m-n=32−2=30) resource elements not used by the n=2-port CSI-RS.

So far we have discussed example locations, within a subframe, of the resource elements allocated to CSI-RS resources.

Now we show how the row 3, 2-port CSI-RS and row16, 32-port CSI-RS can be configured so the transmitted signal for the two ports of the row 3-CSI-RS is exactly the same as that for any of two port CDM group of the row16, 32-port CSI-RS. By applying such configuration, a UE configured to use an n-port NZP CSI-RS will not notice that its n-port NZP CSI-RS resource is actually part of a larger m-port NZP CSI-RS resource in the sense that the selected precoder would be the same as if the NZP CSI-RS had been configured using a prior-art technique such as that depicted in FIGS. 2A and 2B.

As defined in 3GPP TS 38.211 V15.1.0 (2018-03), the transmitted complex number for a NZP CSI-RS resource for port p, subcarrier k (global subcarrier index), OFDM symbol l (with respect to slot boundary), and numerology index μ, is given by

$${a}_{k , l}^{( p , μ )} = {β}_{C SIRS} {w}_{f} ( {k}^{′} ) \cdot {w}_{t} ( {l}^{′} ) \cdot {r}_{l , {n}_{s , f}} ( {m}^{′} )$$

$${m}^{′} = ⌊ n α ⌋ + {k}^{′} + ⌊ \frac{\overline{k} ρ}{{N}_{s c}^{R B}} ⌋$$

$$k = n {N}_{sc}^{RB} + \overline{k} + {k}^{′}$$

$$l = \overline{l} + {l}^{′}$$

$$α = \{ \begin{matrix}ρ & for X = 1 \\ 2 ρ & for X > 1\end{matrix} \\ n = 0 , 1 , …$$

The a_{k,l}^{(p,u)} is a function of numerology, port, subcarrier (global subcarrier index) and symbol number (with respect to slot boundary). Numerology is expected to be the same and does not affect the calculation of a_{k,l}^{(p,u)}), so that does not need to be considered.

The a_{k,l}^{(p,u)} also depends on CDM group type; hence, to have the same sequences (represented by wf and wt), the CDM group type shall be the same.

We start with allocating the two ports (part of CDM group described by k0, 10) of row3-CSI-RS to resource elements of row16-CSI-RS corresponding to any CDM group (ki, lj). This is allowed since b=[b5 b4 b3 b2 b1 b0] and 10 of row3-CSI-RS can be selected to match the (ki, lj) of row16-CSI-RS. For this case, the time dimension of the CDM is not applicable since l′ is always zero. The sequences wf is the same in both cases.

The parameter m′ in r(m′) is calculated from three terms:

The first term containing alpha is the same for the two cases. This is because the value of α is the same (the number of ports X>1 for both cases) and because the resource index n is the same in both cases.

The second term is the subcarrier index k′ within the CDM group relative to k̅ (which in turn is relative to the resource block boundary). All this means that if the subcarrier index k′ within the CDM group is the same for row3-CSI-RS and row16-CSI-RS then also m′ is the same.

The last term containing k̅ does not contribute when rho>1. For rho>1, there would potentially be a dependency on k̅ which means k̅ need to be selected the same for the two resources. However, except for row 1, all rows in table 7.4.1.5.3-1 of [1] the value of rho is <=1.

In other words the quantity a_{k,l}^{(p,u)} is the same for the row3-CSI-RS and row16-CSI-RS. Note: if a_{k,l}^{(p,u)} was not the same (for any reason whatsoever) in the case the n-port CSI-RS resource re-used resource elements of a larger m-port CSI-RS resource (as compared to a stand-alone n-port CSI-RS resource), then this deviation would be absorbed by a corresponding port-to-antenna mapping applied to any PDSCH transmission (in addition to any precoding indicated by PMI) to a UE providing CSI feedback on the (re-using) n-port CSI-RS resource. So far we did not find any practical case where this happened.

It remains to consider the port numbering in a_{k,l}^{(p,u)}. The calculation of a_{k,l}^{(p,u)} is independent of the exact locations of the CDM groups within the resource block. It is only the relative order of the CDM groups that matters for the port numbering. The CDM group index j given in Table 7.4.1.5.3-1 defines the relative ordering of the CDM groups.

The port numbering from 3GPP TS 38.211 V15.1.0 (2018-03) is shown below:

p=3000+s+jL;

j=0,1, . . . ,N/L−1

s=0,1, . . . ,L−1;

If the n-port CSI-RS resource has the same CDM group type as the m-port CSI-RS resource it can reuse the port numbering (some of the indices j will not be used). For row3-CSI-RS row the port numbering does fit into a row16-CSI-RS version of the port numbering above since a row3-CSI-RS j=0 can correspond to any j of the row16-CSI-RS version.

Since a_{k,l}^{(p,u)} is the same for both row3-CSI-RS and row16-CSI-RS one could actually let the row3-CSI-RS be transmitted using the same port-to-antenna mapping (p2a_row16-CSI-RS). That is perfect re-use. However, that means less power is assigned to row3-CSI-RS. As a result, less coverage would be supported for UEs that rely on row3-CSI-RS.

It would be possible to change the port-to-antenna mapping so that the transmission of row3-CSI-RS exploits the full AAS. At such a point in time the row16-CSI-RS would be corrupted (ports now shadowed by row3-CSI-RS cannot be trusted), so UEs relying on row16-CSI-RS would not provide correct CSI feedback (at that point in time).

An intermediate solution would be to exploit the 3GPP option of defining several row3-CSI-RS resources (row3-CSI-RS resource has 2 ports). Each such resource is represented by a CSI-RS Resource Indicator (CRI). A UE not capable of measuring on a row16-CSI-RS (32-ports resource) could in our example above instead be configured to measure on k∈{1, . . . , 16} (2-port) row3-CSI-RS resources, reusing all resource elements of the row16-CSI-RS, where k is signaled from the network to the UE during CSI-RS configuration through RRC signaling; the value of k depends on UE capability, i.e., the maximum number of CSI-RS resources that the UE can measure. The UE reports a preferred CRI together with other CSI aspects like CQI/RI/PMI. In a straight-forward solution, port-to-antenna mapping of each row3-CSI-RS resource would be neutral with respect to spatial aspects. That neutral mapping would in no way interfere with the port-to-antenna mapping of the larger row16-CSI-RS resource, so performance for UEs measuring the row16-CSI-RS resource would be unaffected. At the same time not much gain is expected for the UEs measuring the many row3-CSI-RS resources; each and every row3-CSI-RS resource is subject to the coverage problem mentioned above.

However, if each resource was subject to a steering vector of antenna weights making each resource point in different directions there is potential to mitigate the coverage. This would have impact on the UEs measuring on the row16-CSI-RS resource; these UEs would now sense the AAS as a bit different. That may result in loss of performance, such that the UEs would select a PMI that performs worse compared to a native AAS. Still the steering of the resource elements is totally transparent to the UEs relying on the 32-port version of the AAS; they are unaware the AAS is now a little bit strange (because of the steering of the smaller resources).

All in all, this intermediate solution offers the opportunity to trade performance of UEs measuring on row16-CSI-RS for coverage of UEs measuring on row3-CSI-RS given that same resource elements are used for both row16-CSI-RS and row3-CSI-RS. The tradeoff can be adjusted dynamically by the network by choosing whether to apply port-to-antenna mapping that is optimized for row3-CSI-RS UEs or row16-CSI-RS, or a mapping in between, depending on the number of UEs supporting row16-CSI-RS and row3-CSI-RS, as well as their traffic requirements and service class (e.g., gold, silver, and bronze users). Another alternative is to configure the UEs with time domain measurement restriction feature, where the UEs are asked not to average the CSI-RS measurement done over periodic CSI-RS transmissions over-time. By doing so, the network may then:
Decide in one CSI-RS transmission to optimize the port-to-antenna mapping to row16-CSI-RS UEs
Decide in another CSI-RS transmission to optimize the port-to-antenna mapping to row3-CSI-RS UEs

This way, the network can receive different types of CSI-RS feedbacks depending on the port-to-antenna mapping used for the CSI-RS transmission. The network can aggregate these CSI-RS feedbacks with the corresponding port-to-antenna mappings used to obtain the most suitable precoding and transport-block format (including modulation and coding) to be used for transmission for the UE. A more advanced option would be to have the network undo any precoding related to the row3-CSI-RS resources when interpreting CSI feedback from UEs measuring on row16-CSI-RS.

It is also possible to use this invention in the context of MU-MIMO. In MU-MIMO, multiple UEs can be co-scheduled in the same time-frequency resource block by separating their intended signals in spatial domain through smart-precoding and smart selection of UEs to be co-scheduled. One way to harness the gains of MU-MIMO, is to find which UEs to group for co-scheduling by estimating the CSI when they are co-scheduled. For instance, assume we want to co-schedule up to 3 UEs, then we need to evaluate the CSI for the following hypotheses and pick the one that achieve the best aggregate performance for the 3 UEs according to any objective function:

No co-scheduling: in this case, UE1, UE2, UE3 measure their CSI assuming the only interference is coming from inter-cell interference plus thermal noise

All 3 UEs are scheduled: in this case:
UE1 measures its CSI assuming the interference will come from the intra-cell transmission intended to UE2 and UE3, in addition to inter-cell interference and thermal noise.
UE2 measures its CSI assuming the interference will come from the intra-cell transmission intended to UE1 and UE3, in addition to inter-cell interference and thermal noise.
UE3 measures its CSI assuming the interference will come from the intra-cell transmission intended to UE1 and UE2, in addition to inter-cell interference and thermal noise.

Only UE1 and UE2 are co-scheduled:
UE1 measures its CSI assuming the interference will come from the intra-cell transmission intended to UE2, in addition to inter-cell interference and thermal noise.
UE2 measures its CSI assuming the interference will come from the intra-cell transmission intended to UE1, in addition to inter-cell interference and thermal noise.
UE3 measures its CSI assuming the interference will come from inter-cell interference and thermal noise.

Only UE1 and UE3 are co-scheduled:
UE1 measures its CSI assuming the interference will come from the intra-cell transmission intended to UE3, in addition to inter-cell interference and thermal noise.
UE2 measures its CSI assuming the interference will come from inter-cell interference and thermal noise.
UE3 measures its CSI assuming the interference will come from the intra-cell transmission intended to UE1, in addition to inter-cell interference and thermal noise.

Only UE2 and UE3 are co-scheduled:
UE1 measures its CSI assuming the interference will come from inter-cell interference and thermal noise.
UE2 measures its CSI assuming the interference will come from the intra-cell transmission intended to UE3, in addition to inter-cell interference and thermal noise.
UE3 measures its CSI assuming the interference will come from the intra-cell transmission intended to UE2, in addition to inter-cell interference and thermal noise.

One way to evaluate the above hypothesizes is to configure 3 NZP-CSI-RS resources, each pre-coded towards a particular one of the 3 UEs. Each UE can then be configured to measure the CSI for all hypotheses (e.g., in the 2nd hypothesis above, to compute CSI, the UE will use its NZP-CSI-RS to measure the channel, the 2 NZP-CSI-RS resources precoded for UE2 and UE3 to measure intracell interference, and it will use CSI-IM to measure inter-cell interference and noise). Now assume these 3 UEs can support up to 2-port CSI-RS measurement using row3-CSI-RS. In this case, the 3 NZP-CSI-RS can be configured as 3 row3-CSI-RS resources as part of one row16-CSI-RS resource. It has to be noted though that the CSI-RS feedback that is reported by a UE measuring on row16-CSI-RS will be weighted with the precoding used for UE1,UE2,UE3, and the network has to take that into account when deciding the precoding to be used for the UE measuring on row16-CSI-RS (e.g., the network might “undo” the effect of the precoding of UE1,UE2,UE3 on the reported PMI).

Based on the example above, the following generic rules are stated for the case when same port-to-antenna mapping is used for the two CSI-RS resources (this includes when several smaller CSI-RS resources are beamformed, in other words are subject to steering):
Both the m-port CSI-RS and n-port CSI-RS should be configured with the same CDM type.
For the wf/wt sequences to work out for the smaller CSI-RS a simple strategy is to select subset of the CDM groups of the larger CSI-RS to be re-used for the smaller CSI-RS.
The order of the CDM groups selected from the larger CSI-RS resource is not important.
The resource elements of the n-port CSI-RS should be a subset of the resource elements of the m-port CSI-RS.
Resource elements part of the larger CSI-RS resource but not of any smaller CSI-RS resource shall be represented by ZP CSI-RS resource

Based on the example above, the following generic rule is stated for the case when different port-to-antenna mapping is used for the two CSI-RS resources:
CDM groups of the smaller CSI-RS can be selected freely as long as no more resource elements is used as corresponds to the large CSI-RS (since the larger CSI-RS is anyway corrupted).
The same complex number a_{k,l}^{(p,u)} can be used in both cases (it is only the port-to-antenna mapping that differs)
Resource elements part of the larger CSI-RS resource but not of any smaller CSI-RS resource shall be represented by ZP CSI-RS resource

In the previous discussion, we provided an example where a 32-port CSI-RS resource can be reused as a 2-port CSI-RS resource configured with row 3. In Table 1, we provide more possibilities for reusing an m-port CSI-RS as n-port CSI-RS,

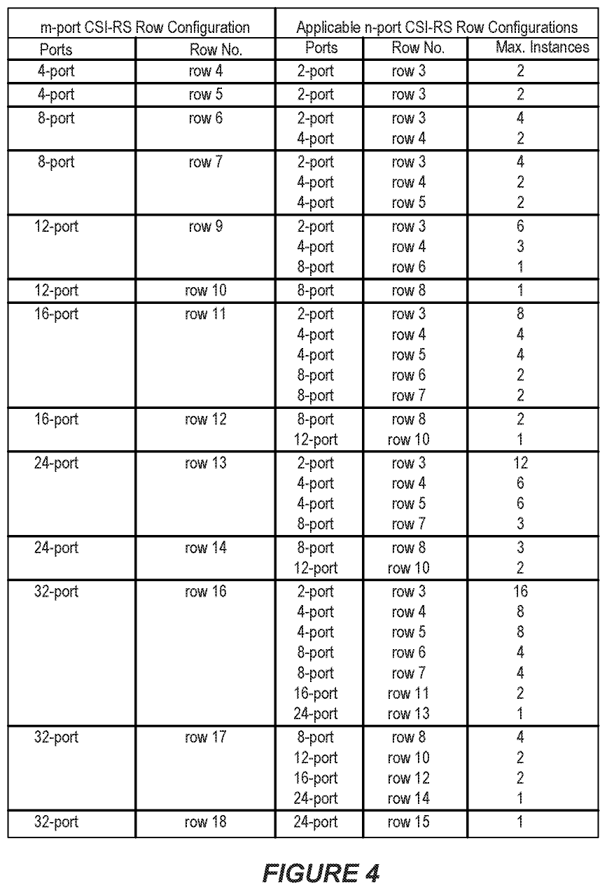

It is straightforward to reuse a m-port CSI-RS resource as multiple n₁-ports CSI-RS resources. For instance, by referring to the table in FIG. 4, it can be seen that it is possible to reuse 32-port CSI-RS resource configured with row 16 as one or more of the following CSI-RS resource configurations: (2-port, row 3), (4-port, row 4), (4-port, row 5), (8-port, row 6), (8-port, row 7), (16-port, row 11), (24-port, row 13). This especially useful when the network serves different UEs with different capabilities of the number of CSI-RS ports.

As explained previously, ZP-CSI RS is needed to be configured for UE who is measuring at least one n-port CSI-RS and it should cover at least the resource elements that are not used by any n-port CSI-RS configured for the UE (there could be many, each labeled with CRI). We note that such ZP CSI-RS is needed if a UE which is configured with one or more n-port CSI-RS is scheduled PDSCH data in one or more resource blocks (RBs) containing the m-port CSI-RS. If for some reason the UE will never be scheduled PDSCH data in any RB containing the m-port CSI-RS, then ZP CSI-RS is not needed in this case.

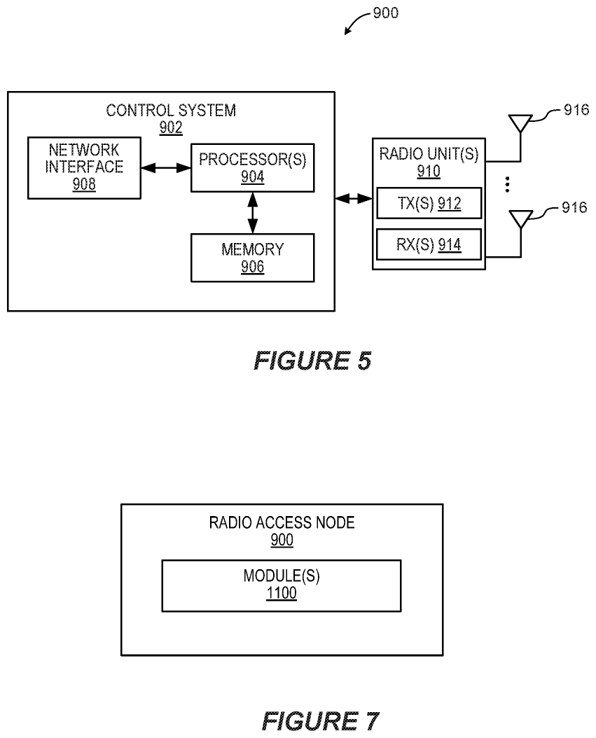

FIG. 5 is a schematic block diagram of a radio access node 900 according to some embodiments of the present disclosure. The radio access node 900 may be, for example, a base station 102. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. In addition, the radio access node 900 includes one or more radio units 910 that each includes one or more transmitters 912 and one or more receivers 914 coupled to one or more antennas 916. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

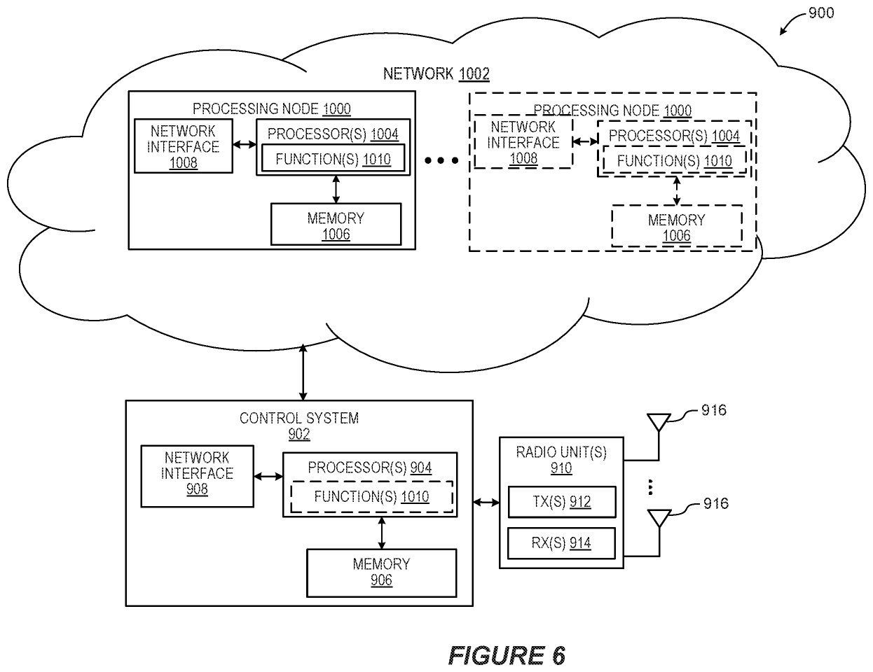

FIG. 6 is a schematic block diagram that illustrates a virtualized embodiment of the radio access node 900 according to some embodiments of the present disclosure. This discussion is equally applicable to other types of network nodes. Further, other types of network nodes may have similar virtualized architectures.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 includes the control system 902 that includes the one or more processors 904 (e.g., CPUs, ASICs, FPGAs, and/or the like), the memory 906, and the network interface 908 and the one or more radio units 910 that each includes the one or more transmitters 912 and the one or more receivers 914 coupled to the one or more antennas 916, as described above. The control system 902 is connected to the radio unit(s) 910 via, for example, an optical cable or the like. The control system 902 is connected to one or more processing nodes 1000 coupled to or included as part of a network(s) 1002 via the network interface 908. Each processing node 1000 includes one or more processors 1004 (e.g., CPUs, ASICs, FPGAs, and/or the like), memory 1006, and a network interface 1008.

In this example, functions 1010 of the radio access node 900 described herein are implemented at the one or more processing nodes 1000 or distributed across the control system 902 and the one or more processing nodes 1000 in any desired manner. In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method in an access node of a wireless network, the method comprising:
transmitting a first Non-Zero Power (NZP) Channel State Information Reference Signal (CSI-RS) in a first set of resource elements of a subframe, the first NZP CSI-RS having a respective first number of ports;
transmitting at least one second NZP CSI-RS in a second set of resource elements of the subframe, the second set of resource elements being a subset of the first set of resource elements, each second NZP CSI-RS having a respective second number of ports that is less than the first number of ports; and
configuring at least one user equipment (UE) to perform rate matching using one or more Zero Power (ZP) CSI-RSs in a third set of resource elements of the subframe, the third set of resource elements overlapping the first set of resource elements and not overlapping the second set of resource elements.

2. The method of claim 1, wherein the at least one second NZP CSI-RS comprises two or more second NZP CSI-RSs, each one of the two or more second NZP CSI-RSs having a respective second number of ports.

3. The method of claim 2, wherein the respective second number of ports of one second NZP CSI-RS is different than the respective second number of ports of another second NZP CSI-RS.

4. The method of claim 2, wherein a sum of the second numbers of ports is equal to or less than the first number of ports.

5. The method of claim 1, wherein each ZP CSI-RS has a respective third number of ports

6. The method of claim 5, wherein the respective third number of ports of one ZP CSI-RS is different than the respective third number of ports of another ZP CSI-RS.

7. The method of claim 5, wherein a sum of the third numbers of ports is equal to or greater than a difference between the first number of ports and a sum of the second numbers of ports.

8. The method of claim 1, wherein the first NZP CSI-RS is configured such that a signal transmitted in at least one group of n ports of the first NZP CSI-RS, where n is an integer equal to a particular second number of ports, is identical to a corresponding signal transmitted in the respective second NZP CSI-RS.

9. The method of claim 1, wherein:
the first number of ports is selected from a list consisting of 4, 8, 12, 16, 24 and 32; and
the second number of ports is selected from the list consisting of 2, 4, 8, 12, 16 and 24.

10. The method of claim 1, further comprising configuring a particular one of the at least one UE to measure a channel state using the first NZP CSI-RS.

11. The method of claim 1, further comprising configuring a particular one of the at least one UE to measure a channel state using the at least one second NZP CSI-RS.

12. An access node of a wireless communications network, the access node comprising:
at least one processor; and
a non-transitory computer readable medium storing software instructions configured to control the at least one processor to implement a process comprising:
transmitting a first Non-Zero Power (NZP) Channel State Information Reference Signal (CSI-RS) in a first set of resource elements of a subframe, the first NZP CSI-RS having a respective first number of ports;
transmitting at least one second NZP CSI-RS in a second set of resource elements of the subframe, the second set of resource elements being a subset of the first set of resource elements, each second NZP CSI-RS having a respective second number of ports that is less than the first number of ports; and
configuring at least one user equipment (UE) in a coverage area of the access node to perform rate matching using one or more Zero Power (ZP) CSI-RSs in a third set of resource elements of the subframe, the third set of resource elements overlapping the first set of resource elements and not overlapping the second set of resource elements.

13. The access node of claim 12, wherein the at least one second NZP CSI-RS comprises two or more second NZP CSI-RSs, each one of the two or more second NZP CSI-RSs having a respective second number of ports.

14. The access node of claim 13, wherein the respective second number of ports of one second NZP CSI-RS is different than the respective second number of ports of another second NZP CSI-RS.

15. The access node of claim 13, wherein a sum of the second numbers of ports is equal to or less than the first number of ports.

16. The access node of claim 12, wherein each ZP CSI-RS has a respective third number of ports

17. The access node of claim 16, wherein the respective third number of ports of one ZP CSI-RS is different than the respective third number of ports of another ZP CSI-RS.

18. The access node of claim 16, wherein a sum of the third numbers of ports is equal to or greater than a difference between the first number of ports and a sum of the second numbers of ports.

19. The access node of claim 12, wherein the first NZP CSI-RS is configured such that a signal transmitted in at least one group of n ports of the first NZP CSI-RS, where n is an integer equal to a particular second number of ports, is identical to a corresponding signal transmitted in the respective second NZP CSI-RS.

20. The access node of claim 12, wherein:
the first number of ports is selected from a list consisting of 4, 8, 12, 16, 24 and 32; and
the second number of ports is selected from the list consisting of 2, 4, 8, 12, 16 and 24.

21. The access node of claim 12, further comprising software instructions configured to control the at least one processor to configure a particular one of the at least one UE to measure a channel state using the first NZP CSI-RS.

22. The access node of claim 12, further comprising software instructions configured to control the at least one processor to configure a particular one of the at least one UE to measure a channel state using the at least one second NZP CSI-RS.
